(19) United States
(12) Patent Application Publication
(10) Pub. No.: US 2011/0183093 A1
(43) Pub. Date: Jul. 28, 2011

(54) PRESSURE-SENSITIVE ADHESIVE SHEET

(75) Inventors: Shouhei WADA, Ibaraki-shi (JP); Akiko TAKAHASHI, Ibaraki-shi (JP); Mitsuyoshi SHIRAI, Ibaraki-shi (JP); Toshihide SUZUKI, Ibaraki-shi (JP); Kenichi YAMAMOTO, Ibaraki-shi (JP)

(73) Assignee: NITTO DENKO CORPORATION, Ibaraki-shi (JP)

(21) Appl. No.: 13/010,615

(22) Filed: Jan. 20, 2011

(30) Foreign Application Priority Data
Jan. 22, 2010 (JP) 2010-012343

(51) Int. Cl. B32B 7/12; C09J 7/02; B32B 7/02; C09J 133/02

(52) U.S. Cl. 428/35.7; 428/354; 428/216; 526/224

(57) ABSTRACT

The present invention provides a pressure-sensitive adhesive (PSA) sheet which is formed using a non-toluene solvent-based acrylic PSA composition, and which minimizes corrosion of metals not in contact with the PSA sheet. PSA sheet 1 has PSA layers 21, 22 formed from a solvent-based PSA composition. The PSA composition includes, within an organic solvent that is substantially free of toluene substances, an acrylic polymer synthesized in presence of a sulfur-containing chain transfer agent. Moreover, in a gas generation test whereby PSA sheet 1 is heated at 85° C. for one hour, the emission of sulfur-containing gas is 0.043 μg or less per 1 cm² surface area of PSA sheet 1, when converted to SO₄²⁻.

### CROSS-REFERENCE

This application claims priority to Japanese Patent Application No. 2010-012343 filed on Jan. 22, 2010, the entire contents of which are incorporated herein by reference.

### BACKGROUND OF THE INVENTION

1. Field of the Invention

The present invention relates to a solvent-based pressure-sensitive adhesive (PSA) composition in which an acrylic copolymer serves as the base polymer, and to a PSA sheet made from such a PSA composition.

2. Description of the Related Art

PSA sheets made with a solvent-based acrylic PSA composition are employed in various types of electronic device such as home electrical appliance and office automation equipment, in housing materials and interior materials, and in a variety of other fields as well. Up until now, toluene has been commonly used as the organic solvent in solvent-based PSA compositions. However, environmental health concerns have prompted a demand for lower toluene emissions, creating a desire for the use of non-toluene-based organic solvents. Technical literature relating to solvent-type PSA compositions is exemplified by Japanese Patent Application Publication No. 2000-303049.

### SUMMARY OF THE INVENTION

Depending on the manner of use, PSA sheets formed from acrylic PSA compositions sometimes cause metals (e.g., silver) which are not in direct contact with the PSA sheet to corrode. For example, under circumstances where a PSA sheet and a metallic material are both present within a confined space, such as at the interior of the housing for an electronic device, corrosion sometimes arises in the metallic material which is not in direct contact with the PSA sheet. Such a situation may become a cause that gives rise to poor electrical contact due to corrosion of the metal making up, for example, the substrate or wiring of the electronic device. Therefore, the quality of not causing metal to corrode is especially desired in PSA sheets for use inside electronic devices. Moreover, such metal corrosion may, in areas other than electronic equipment, give rise to undesirable effects, such as a decline in the quality of the appearance. Therefore, a PSA sheet which does not cause metal to corrode is desired.

The object of the present invention is to provide a PSA sheet which is made from a non-toluene organic solvent-based acrylic PSA composition, and which minimizes the corrosion of metals not in direct contact with the PSA sheet (sometimes referred to below as “non-contact metals”).

The inventors, thinking that the corrosion of non-contact metals caused by a PSA sheet may arise due to the release of metal-corroding substances from the PSA sheet, have focused their attention on sulfur-containing gases (i.e., gases containing sulfur as a constituent atom) as such metal-corroding substances. In addition, they have determined that sulfur compounds widely used as chain transfer agents in the production of acrylic polymers for PSA (sulfur-containing chain transfer agents, typically, n-laurylmercaptan) may become a major source of such sulfur-containing gases. Furthermore, they have discovered that, even when a sulfur-containing chain transfer agent is used, the above problem of metal corrosion can be resolved by minimizing the release of such sulfur-containing gases.

Accordingly, the present invention provides a PSA sheet having a PSA layer formed from a solvent-based PSA composition. The PSA composition includes, within an organic solvent that is substantially free of toluene substances, an acrylic polymer synthesized in presence of a chain transfer agent containing sulfur as a constituent atom (sulfur-containing chain transfer agent). Moreover, in a gas generation test whereby the PSA sheet is heated at 85° C. for one hour, the emission of gas containing sulfur as a constituent atom (sulfur-containing gas) per 1 cm² surface area of the PSA sheet is 0.043 μg or less when converted to SO₄²⁻ (this is sometimes indicated below as “0.043 μg SO₄²⁻/cm² or less”). In this specification, the phrase “organic solvent that is substantially free of toluene substances” (or “non-toluene organic solvent”) refers to:

(1) organic solvents (e.g., ethyl acetate) which do not correspond to, of the 13 substances which are the target of restrictions by Japanese Ministry of Health, Labor and Welfare as causative substances capable of giving rise to sick building syndrome, any benzene ring-containing substances that are capable of being used as a solvent (that are liquid at room temperature) (i.e., toluene, xylene, ethylbenzene, styrene, p-dichlorobenzene, di-n-butyl phthalate, di-2-ethylhexyl phthalate; these are sometimes referred to collectively below as “toluene substances” or “toluene organic solvents”); or

(2) organic solvents (which may be mixed solvents) that contain substantially none of these toluene substances (e.g., in which the total content of such toluene substances is below 1,000 ppm). Also, “solvent-based PSA composition” refers to a composition in a form where the PSA component is dissolved in an organic solvent.

With such a PSA sheet, the emission of sulfur-containing gases (especially gases capable of reacting with metals such as silver to form sulfides; e.g., H₂S, SO₂) is suppressed, thus making it possible to effectively prevent or suppress corrosion of the above metal (e.g., formation of the above sulfides). Also, because the use of a sulfur-containing chain transfer agent in the synthesis of the acrylic polymer is allowed, adjusting the polymer to a suitable molecular weight is easy. With a PSA composition containing an acrylic polymer having a suitably adjusted molecular weight, a PSA sheet endowed with a higher performance can be formed. Therefore, according to this invention, there can be obtained a PSA sheet having an excellent ability to prevent metal corrosion and a good PSA performance.

In a preferred aspect of the art disclosed herein, the sulfur-containing chain transfer agent is a chain transfer agent which substantially does not generates the sulfur-containing gas in the gas generation test. With a PSA sheet according to this aspect, a higher metal corrosion preventability can be achieved.

It is preferable for the sulfur-containing chain transfer agent to be a mercaptan in which one hydrogen atom or less is bonded to the carbon atom bonded to the mercapto group (inclusive of mercaptans in which no hydrogen atom is bonded to the carbon atom), or a chain transfer agent in which the primary component (i.e., the component accounting for at least 50 mass % of the sulfur-containing chain transfer agent) is a mercaptan in which the carbon atoms form a resonance structure. Preferred examples of such mercaptans include tertiary mercaptans and aromatic mercaptans.

It is preferable to use as the organic solvent one which has a boiling point under a pressure of 1 atm which lies in a range of from 25° C. to 109° C. Preferred examples of such organic solvents include ethyl acetate, hexane, cyclohexane, methylcylohexane and isopropyl alcohol.

An example of a preferred application of the art disclosed herein is a double-sided PSA sheet (also known as two-sided PSA sheet, double-faced PSA sheet or double-stick sheet) comprising a substrate having on each side thereof the PSA layer. In a PSA sheet having such a construction, adjusting the molecular weight of the acrylic polymer is of particular importance. Hence, the ability to use a sulfur-containing chain transfer agent during synthesis of the acrylic polymer is of particular significance.

As mentioned above, because the PSA sheet provided by the art disclosed herein releases very little metal-corroding gas, it is highly suitable as a PSA sheet for use inside an electronic device. For example, it can be advantageously employed as a PSA sheet used for bonding within an interior space where it is present together with metal materials such as a circuit board or wiring. The present invention thus provides, in another aspect, an electronic device which has at the interior thereof a bonded place that are bonded by means of the PSA sheet.

The subject matter disclosed in the present specification includes the following:

(1) A PSA sheet having a PSA layer formed from a solvent-based PSA composition, wherein the composition includes, within a non-toluene organic solvent, an acrylic polymer synthesized in presence of at least one species of mercaptan selected from the group consisting of tertiary mercaptans and aromatic mercaptans;

the emission of sulfur-containing gas being 0.043 μg SO₄²⁻/cm² or less in a gas generation test whereby the PSA sheet is heated at 85° C. for one hour.

(2) A solvent-type PSA composition containing, within a non-toluene organic solvent, an acrylic polymer synthesized in presence of a sulfur-containing chain transfer agent,

the emission of sulfur-containing gas per 1 g of the PSA converted into SO₄²⁻ being 2.7 μg or less (hereinafter, may be represented as “2.7 μg SO₄²⁻/g or less”) in a gas generation test whereby a PSA obtained by drying or solidifying the composition is heated at 85° C. for one hour.

### BRIEF DESCRIPTION OF THE DRAWINGS

FIG. 1 is a schematic cross-sectional view of a construction example of the PSA sheet according to the present invention;

FIG. 2 is a schematic cross-sectional view of another construction example of the PSA sheet according to the invention;

FIG. 3 is a schematic cross-sectional view of yet another construction example of the PSA sheet according to the invention;

FIG. 4 is a schematic cross-sectional view of a further construction example of the PSA sheet according to the invention;

FIG. 5 is a schematic cross-sectional view of a still further construction example of the PSA sheet according to the invention; and

FIG. 6 is a schematic cross-sectional view of an additional construction example of the PSA sheet according to the invention.

### DETAILED DESCRIPTION OF THE INVENTION

Preferred embodiments of the present invention will be described below. Technical matters necessary to practice the invention, other than those specifically referred to in the present description, may be understood as design matters for a person skilled in the art that are based on the related art in the pertinent field. The present invention may be practiced based on the contents disclosed herein and common general technical knowledge in the pertinent field. In the following description, members or features having like functions are designated by like symbols, and repeated explanations may be omitted or simplified.

The PSA sheet provided by this invention has a PSA layer formed from any one of the solvent-based PSA compositions disclosed herein. It may be a PSA sheet with substrate in a form having the PSA layer on one side or both sides of a substrate (base material), or a substrate-less PSA sheet in which the PSA layer is held on a release liner (which may also be understood to be a substrate having a release face). The notion of a PSA sheet as used herein may encompass, for example, what are commonly referred to as PSA tape, PSA labels and PSA film. The PSA layer, although typically formed continuously, is not limited to such a configuration and may instead be a PSA layer formed in a regular (e.g., dotted or striped) pattern or in a random pattern. The PSA sheet provided by the present invention may be shaped as a roll or as single sheets. Alternatively, the PSA sheet may be in a form that has been fashioned into any of various other shapes.

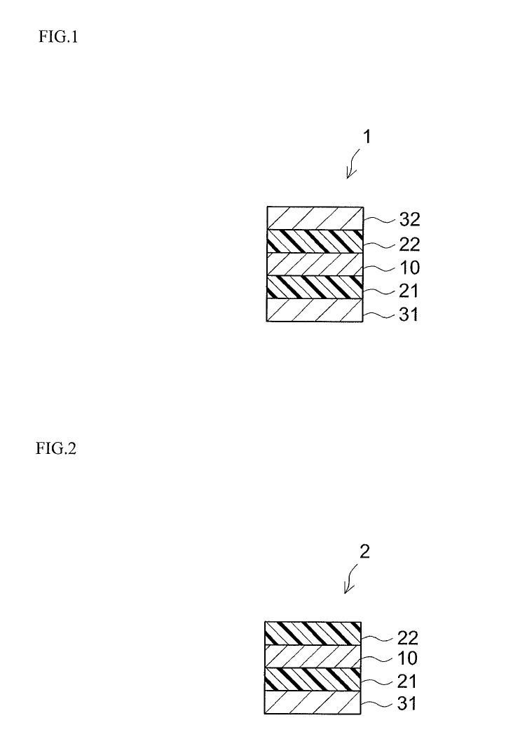

The PSA sheet disclosed herein may have, for example, the cross-sectional structures shown schematically in FIGS. 1 to 6. Among these, FIGS. 1 and 2 show examples of double-sided adhesive PSA sheet-with-substrate constructions (double-sided PSA with a substrate). The PSA sheet 1 shown in FIG. 1 has a construction wherein PSA layers 21 and 22 are respectively provided on each side (both of which are non-releasable) of a substrate 10, and these PSA layers are respectively protected by release liners 31 and 32, each of which has a release face on at least the PSA layer side thereof. The PSA sheet 2 shown in FIG. 2 has a construction wherein PSA layers 21 and 22 are respectively provided on each side (both of which are non-releasable) of a substrate 10, and one of these—PSA layer 21—is protected by a release liner 31 having a release face on each side thereof. By rolling up this PSA sheet 2 and placing the other PSA layer 22 directly against the back face of the release liner 31, the PSA sheet 2 can be given a configuration in which the PSA layer 22 also is protected by the release liner 31.

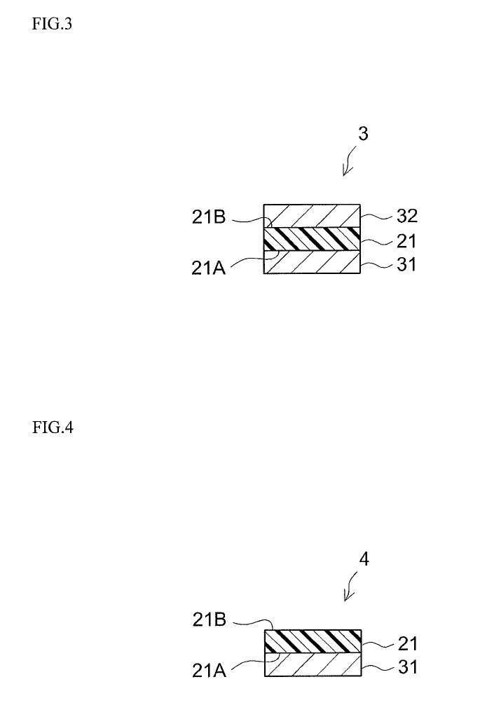

FIGS. 3 and 4 show examples of substrate-less double-sided adhesive PSA sheet constructions. The PSA sheet 3 shown in FIG. 3 has a construction wherein the faces 21A and 21B of a substrate-less PSA layer 21 are protected by, respectively, release liners 31 and 32, each of which has a release face on at least the PSA layer side thereof. The PSA sheet 4 shown in FIG. 4 has a construction wherein a first face 21A of a substrate-less PSA layer 21 is protected by a release liner 31 having a release face on each side thereof. By rolling up this PSA sheet 4 and placing the second face 21B of the PSA layer 21 directly against the back face of the release liner 31, the PSA sheet 4 can be given a configuration in which the second face 21B also is protected by the release liner 31.

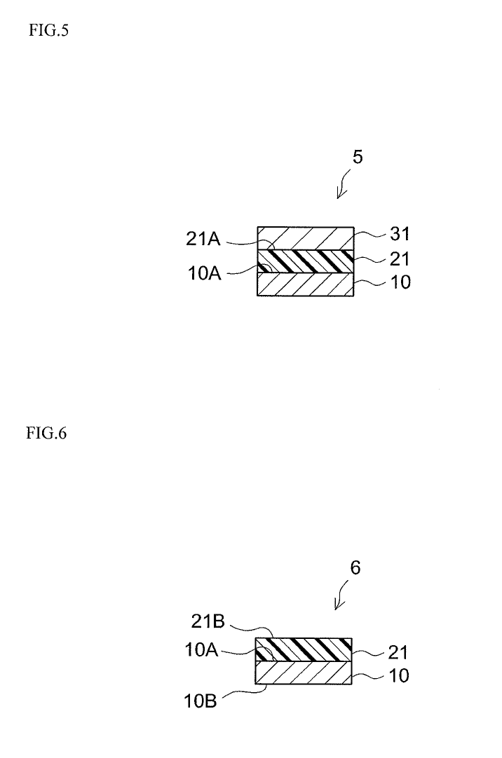

FIGS. 5 and 6 show examples of single-sided adhesive (adhesive on one side) PSA sheet-with-substrate constructions. The PSA sheet 5 shown in FIG. 5 has a construction wherein a PSA layer 21 is provided on a first face 10A (non-releasable face) of a substrate 10, and a surface (bonding face) 21A of the PSA layer 21 is protected by a release liner 31 having a release face on at least the PSA layer side thereof. The PSA sheet 6 shown in FIG. 6 has a construction wherein a PSA layer 21 is provided on a first face 10A (non-releasable face) of a substrate 10. A second face 10B of the substrate 10 is a release face. When this PSA sheet 6 is rolled up, the second face 10B is brought directly against the PSA layer 21, and a surface (bonding face) 21B of the PSA layer 21 is protected by the second face 10B of the substrate.

The PSA composition used in the formation of the PSA layer includes an acrylic polymer. This acrylic polymer is an acrylic polymer composition in the form wherein an acrylic polymer is dispersed in a non-toluene organic solvent. In the art disclosed herein, this acrylic polymer may be used as the base polymer of the PSA (the base ingredient of the PSA) in the PSA layer. For example, it is preferable for the acrylic polymer to account for at least 50 wt % of the PSA. This acrylic polymer is preferably one in which an alkyl (meth)acrylate serves as the chief monomeric ingredient (i.e., an ingredient which accounts for at least 50 wt % of the total amount of monomers making up the acrylic polymer).

In this specification, “(meth)acrylate” refers collectively to acrylate and methacrylate. Similarly, “(meth)acryloyl” refers collectively to acryloyl and methacryloyl, and “(meth)acryl” refers collectively to acryl and methacryl.

Preferred use may be made of a compound of Formula (1) below as the alkyl (meth)acrylate.

CH₂═C(R¹)COOR² Formula (1)

In Formula (1), R¹ is a hydrogen (H) or a methyl group, and R² is an alkyl group having from 1 to 20 carbon atoms. Illustrative examples of R² include alkyl groups such as methyl, ethyl, propyl, isopropyl, n-butyl, isobutyl, s-butyl, t-butyl, pentyl, isoamyl, neopentyl, hexyl, heptyl, octyl, isooctyl, 2-ethylhexyl, nonyl, isononyl, decyl, isodecyl, undecyl, dodecyl, tridecyl, tetradecyl, pentadecyl, hexadecyl, heptadecyl, octadecyl, nonadecyl and eicosyl. From the standpoint of such considerations as the storage elastic modulus of the PSA, an alkyl (meth)acrylate in which R² is an alkyl group having from 2 to 14 carbon atoms (such a range in the number of carbon atoms is sometimes indicated below as “C₂₋₁₄”) is preferred, and an alkyl (meth)acrylate in which R² is a C₂₋₁₀ alkyl group is more preferred. Especially preferred examples of R² are butyl and 2-ethylhexyl. These alkyl (meth)acrylates may be used singly or as combinations of two or more thereof.

Illustrative examples of the alkyl (meth)acrylates having a C₂₋₁₄ alkyl group include ethyl (meth)acrylate, propyl (meth)acrylate, isopropyl (meth)acrylate, n-butyl (meth)acrylate, isobutyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate and tetradecyl (meth)acrylate.

In one preferred embodiment, at least about 50 wt % (more preferably at least 70 wt %, such as about 90 wt % or more) of the total amount of alkyl (meth)acrylate used to synthesize the acrylic polymer is an alkyl (meth)acrylate in which R² in Formula (1) is C₂₋₁₄ (preferably C₂₋₁₀, and more preferably C₄₋₈). With such a monomer makeup, an acrylic polymer having a storage elastic modulus near standard temperature (typically, around room temperature) that falls within a preferable range can readily be obtained. Essentially all of the alkyl (meth)acrylate used may be C₂₋₁₄ alkyl (meth)acrylate.

Especially preferred alkyl (meth)acrylates include n-butyl acrylate (BA) and 2-ethylhexyl acrylate (2-EHA). For example, the primary monomer may be composed of BA alone, of 2-EHA alone, of the two compounds BA and 2-EHA alone, or of a combination of BA and 2-EHA to which another alkyl (meth)acrylate has been added. When a combination of at least BA and 2-EHA is used as the primary monomer, no particular limitation is imposed on the ratio in which these two compounds are used.

Monomer components in the acrylic polymer may also include, within a range such that an alkyl (meth)acrylate is the chief ingredient, other monomers that are copolymerizable with the alkyl (meth)acrylate (also referred to below as “copolymerizable monomers”). The amount of alkyl (meth)acrylate relative to the overall amount of monomer components making up the acrylic polymer may be set to at least about 80 wt % (typically, from 80 to 99.8 wt %), and preferably at least 85 wt % (e.g., from 85 to 99.5 wt %). The amount of the alkyl (meth)acrylate may be at least 90 wt % (e.g., from 90 to 99 wt %).

The copolymerizable monomers may be useful for introducing crosslink points into the acrylic polymer or for increasing the cohesive strength of the acrylic polymer. These copolymerizable monomers may be used singly or as combinations of two or more thereof.

More specifically, various functional group-bearing monomers may be used as copolymerizable monomers for introducing crosslink points into the acrylic polymer (these are typically thermally crosslinkable functional group-bearing monomers for introducing into the acrylic polymer crosslink points that crosslink under the effect of heat). By using such functional group-bearing monomers, the adhesive strength with respect to the adherend can be enhanced. Such functional group-bearing monomers are not subject to any particular limitation, provided they are monomers which are copolymerizable with alkyl (meth)acrylate and are capable of providing functional groups that will serve as crosslink points. For example, functional group-bearing monomers such as those mentioned below may be used singly or as combinations of two or more thereof.

Carboxyl group-bearing monomers: e.g., ethylenically unsaturated monocarboxylic acids such as acrylic acid, methacrylic acid and crotonic acid; ethylenically unsaturated dicarboxylic acid such as maleic acid, itaconic acid and citraconic acid, as well as anhydrides thereof (e.g., maleic anhydride, itaconic anhydride).

Hydroxyl group-bearing monomers: e.g., hydroxyalkyl (meth)acrylates such as 2-hydroxyethyl (meth)acrylate, 2-hydroxypropyl (meth)acrylate, 3-hydroxypropyl (meth)acrylate and 2-hydroxybutyl (meth)acrylate; and unsaturated alcohols such as vinyl alcohol and allyl alcohol.

Amide group-bearing monomers: e.g., (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide and N-butoxymethyl (meth)acrylamide.

Amino group-bearing monomers: e.g., aminoethyl (meth)acrylate, N,N-dimethylaminoethyl (meth)acrylate and t-butylaminoethyl (meth)acrylate.

Epoxy group-bearing monomers: e.g., glycidyl (meth)acrylate, methylglycidyl (meth)acrylate and allyl glycidyl ether.

Cyano group-bearing monomers: e.g., acrylonitrile, methacrylonitrile.

Keto group-bearing monomers: e.g., diacetone (meth)acrylamide, diacetone (meth)acrylate, vinyl methyl ketone, vinyl ethyl ketone, allyl acetoacetate and vinyl acetoacetate.

Monomers with a N-containing heterocyclic group: e.g., N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam and N-(meth)acryloylmorpholine.

Alkoxysilyl group-bearing monomers: e.g., 3-(meth)acryloxypropyltrimethoxysilane, 3-(meth)acryloxypropyltriethoxysilane, 3-acryloxypropyltriethoxysilane, 3-(meth)acryloxypropylmethyldimethoxysilane and 3-(meth)acryloxypropylmethyldiethoxysilane.

Of such functional group-bearing monomers, preferred use may be made of one or more selected from among carboxyl group-bearing monomers and acid anhydrides thereof. Substantially all of the functional group-bearing monomer ingredients may be carboxyl group-bearing monomers. Of these, examples of preferred carboxyl group-bearing monomers include acrylic acid and methacrylic acid. One of these may be used alone, or acrylic acid and methacrylic acid may be used together in any ratio.

It is advantageous to use the above functional group-bearing monomers in a range of about 12 parts by weight or less (e.g., from about 0.5 to about 12 parts by weight, and preferably from about 1 to about 8 parts by weight) in total per 100 parts by weight of the alkyl (meth)acrylate. If the amount of functional group-bearing monomers used is too high, the cohesive strength may become excessive, as a result of which the adhesive properties (e.g., bonding strength) may tend to decline.

To increase the cohesive strength of the acrylic polymer, additional use may be made of copolymerizable components other than the above functional group-bearing monomers. Illustrative examples of such copolymerizable components include vinyl ester monomers such as vinyl acetate and vinyl propionate; aromatic vinyl compounds such as styrene, substituted styrenes (e.g., α-methylstyrene) and vinyltoluene; nonaromatic ring-bearing (meth)acrylates such as cycloalkyl (meth)acrylates (e.g., cyclohexyl (meth)acrylate, cyclopentyl di(meth)acrylate) and isobornyl (meth)acrylate); aromatic ring-bearing (meth)acrylates such as aryl (meth)acrylates (e.g., phenyl (meth)acrylate), aryloxyalkyl (meth)acrylates (e.g., phenoxyethyl (meth)acrylate) and arylalkyl (meth)acrylates (e.g., benzyl (meth)acrylate); olefinic monomers such as ethylene, propylene, isoprene, butadiene and isobutylene; chlorinated monomers such as vinyl chloride and vinylidene chloride; isocyanate group-bearing monomers such as 2-(meth)acryloyloxyethyl isocyanate; alkoxy group-bearing monomers such as methoxyethyl (meth)acrylate and ethoxyethyl (meth)acrylate; and vinyl ether monomers such as methyl vinyl ether and ethyl vinyl ether.

Other examples of copolymerizable monomer ingredients include monomers having a plurality of functional groups in one molecule. Illustrative examples of such polyfunctional monomers include 1,6-hexanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly)propylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, glycerol di(meth)acrylate, epoxy acrylate, polyester acrylate, urethane acrylate, divinylbenzene, butyl di(meth)acrylate and hexyl di(meth)acrylate.

A known or conventional polymerization method may be employed as the method of polymerizing such monomers to obtain an acrylic polymer. Preferred use may be made of a solution polymerization process. When carrying out solution polymerization, suitable use may be made of monomer feed methods such as a batch charging method in which all the monomer starting material is fed at one time, a continuous feed (dropwise addition) method, or a divided feed (dropwise addition) method. The polymerization temperature may be selected as appropriate for the types of monomers and solvents used, the type of polymerization initiator, etc. For example, the polymerization temperature may be set to from about 20° C. to about 170° C. (typically from about 40° C. to about 140° C.).

The solvent used in solution polymerization may be suitably selected from known or conventional organic solvents. The use of a non-toluene organic solvent having a boiling point under a total pressure of 1 atm in a range of from 20° C. to 200° C. (and especially 25° C. to 109° C.) is preferred. Examples of organic solvents that are especially preferred for use include ethyl acetate, hexane, cyclohexane, methylcyclohexane and isopropyl alcohol. Other organic solvents that may be preferably used include 1-butanol, secondary butanol, tertiary butanol, tertiary butyl methyl ether, methyl ethyl ketone, acetyl acetone and 1,2-dichloroethane.

The polymerization initiator used at the time of polymerization may be suitably selected, according to the type of polymerization method, from among known or conventional polymerization initiators. For example, preferred use may be made of an azo polymerization initiator. Illustrative examples of azo polymerization initiators include 2,2′-azobisisobutyronitrile, 2,2′-azobis(2-methylpropionamidine) disulfate, 2,2′-azobis(2-amidinopropane) dihydrochloride, 2,2′-azobis[2-(5-methyl-2-imidazolin-2-yl)propane]dihydrochloride, 2,2′-azobis(N,N′-dimethyleneisobutylamidine), 2,2′-azobis[N-(2-carboxyethyl)-2-methylpropionamidine]hydrate, 2,2′-azobis(4-methoxy-2,4-dimethylvaleronitrile), 2,2′-azobis(2,4-dimethylvaleronitrile), 2,2′-azobis(2-methylbutylonitrile), 1,1′-azobis(cyclohexane-1-carbonitrile), 2,2′-azobis(2,4,4-trimethylpentane) and dimethyl-2,2′-azobis(2-methylpropionate).

Further examples of polymerization initiators includes persulfates such as potassium persulfate and ammonium persulfate; peroxide initiators such as benzoyl peroxide, t-butyl hydroperoxide, di-t-butyl peroxide, t-butyl peroxy benzoate, dicumyl peroxide, 1,1-bis(t-butylperoxy)-3,3,5-trimethylcyclohexane, 1,1-bis(t-butylperoxy)cyclododecane and hydrogen peroxide; substituted ethane initiators such as phenyl-substituted ethane; aromatic carbonyl compounds; and the like. Still further examples of polymerization initiators include redox initiators such as a combination of a peroxide and reducing agent. Examples of such redox initiators include combinations of peroxides with ascorbic acid (e.g., the combination of an aqueous hydrogen peroxide solution with ascorbic acid), combinations of peroxides with ferric salts (e.g., combination of an aqueous hydrogen peroxide solution with an iron (II) salt (ferrous salt)), and combinations of persulfates with sodium bisulfite.

Such polymerization initiators may be used singly or as a combination of two or more species. The amount in which the initiator is used may be selected from a range of, for example, from about 0.005 to about 1 part by weight (typically from 0.01 to 1 part by weight) per 100 parts by weight of all the monomer components, provided it is an ordinary amount for this purpose.

In a typical aspect of the art disclosed herein, a chain transfer agent (which may be thought of also as a molecular weight adjusting agent or a polymerization degree adjusting agent) composed of a compound containing sulfur as a constituent atom is employed during the above polymerization. The type of such a sulfur-containing chain transfer agent and the amount in which it is used may be set while taking into consideration, for example, the target performance of the PSA sheet and other materials making up the PSA sheet, in such a way that sulfur-containing gases are released, or emitted, therefrom in an amount of 0.043 μg SO₄⁻²/cm² or less (and preferably 0.03 μg SO₄⁻²/cm² or less). Sulfur-containing gas emissions are determined by converting the mass of sulfur-containing gases (H₂S, SO₂, etc.) released from the PSA sheet in a gas generation test wherein the PSA sheet is heated at 85° C. for 1 hour into the mass of SO₄²⁻, and dividing the latter mass by the surface area of the PSA sheet. More specifically, the emissions may be determined by the method of measuring sulfur-containing gas emissions set described in the subsequent examples. In a preferred aspect, regardless of whether a sulfur-containing chain transfer agent is used, the amount of sulfur-containing gases released from the PSA sheet is substantially zero (e.g., as subsequently described, below the limit of detection, typically below 0.02 μg SO₄²⁻/cm², in measurements of the sulfur-containing gas emissions carried out using about 0.1 g of PSA sheet as the measurement sample).

In order to elicit the desired adhesive performance, the amount of sulfur-containing chain transfer agent used per 100 parts by mass of the monomer components is preferably at least about 0.001 part by mass (typically, from about 0.001 to about 5 parts by mass). Generally, more preferred results can be achieved by using from about 0.005 to about 2 parts by mass (typically, from about 0.01 to about 1 part by mass) of the sulfur-containing chain transfer agent per 100 parts by mass of the monomer components. For example, in the synthesis of acrylic polymer for a double-sided PSA sheet, preferred use may be made of an amount within the above-indicated range.

In the art disclosed herein, a compound containing a structural moiety represented as C—SH, i.e., mercaptan, may be used as the sulfur-containing chain transfer agent. In order to achieve a PSA sheet which satisfies the above-indicated sulfur-containing gas emissions, it is preferable to use a sulfur-containing chain transfer agent wherein the primary component is one or more mercaptan selected from among mercaptans having only a single hydrogen atom (H) bonded to the carbon atom (C) to which the mercapto group (—SH) is bonded (e.g., mercaptans in which the mercapto group is bonded to a secondary carbon atom, such as secondary mercaptans), mercaptans in which no hydrogen atom is bonded to the above carbon atom (e.g., mercaptans in which the mercapto group is bonded to a tertiary carbon atom), and mercaptans in which the above carbon atom assumes a resonant structure (e.g., aromatic mercaptans). Mercaptans having such structures do not readily become sulfur-containing gas sources in the acrylic polymer synthesized in the presence of the mercaptan. Therefore, with a solvent-type PSA composition containing such an acrylic polymer, there can be formed a PSA sheet which has a good adhesive performance and metal corrosion by which is prevented. Mercaptans having a structure such as that described above are sometimes referred to below as “corrosion-preventing mercaptans.” Such corrosion-preventing mercaptans may have a structure wherein the carbon atom having the mercapto group bonded thereto is bonded to any atom other than a hydrogen atom. For example, preferred use may be made of a mercaptan having a structure wherein the carbon atom having the mercapto group bonded thereto is bonded to two or three other carbon atoms.

Preferred examples of corrosion-preventing mercaptans include mercaptans having a structure wherein the mercapto group is bonded to a tertiary carbon atom (e.g., a tertiary alkyl group), such as tertiary mercaptans. Examples of tertiary mercaptans include tertiary-butyl mercaptan, tertiary-octyl mercaptan, tertiary-nonyl mercaptan, tertiary-lauryl mercaptan, tertiary-tetradecyl mercaptan and tertiary-hexadecyl mercaptan. The use of a tertiary-alkyl mercaptan having at least four carbon atoms is preferred. From the standpoint of reducing odor from the PSA composition and the PSA sheet, it is advantageous to select a tertiary-alkyl mercaptan having at least 6 carbon atoms (and more preferably at least 8) carbon atoms. There is no particular upper limit in the number of carbon atoms, although the number of atoms is typically 20 or less. For example, tertiary-lauryl mercaptan may be preferably used.

Preferred examples of other corrosion-preventing mercaptans include mercaptans having a structure wherein a mercapto group is bonded to a carbon atom in an aromatic ring or a heteroaromatic ring, i.e., aromatic mercaptans. Preferred examples include aromatic mercaptans having from about 6 to 20 carbon atoms, and heteroaromatic mercaptans having about 2 to 20 carbon atoms and a hetero atom.

The aromatic mercaptan may be a compound having, at least partially in the structure, a bond between an aromatic moiety (typically, an aromatic ring) and a mercapto group; or an isomer thereof; or a mercapto group-bearing derivative. Illustrative examples of aromatic mercaptans include phenyl mercaptan, 4-tolyl mercaptan, 4-methoxyphenyl mercaptan, 2,4-dimethylbenzenethiol, 4-aminobenzenethiol, 4-fluorobenzenethiol, 4-bromobenzenethiol, 4-iodobenzenethiol, 4-t-butylphenyl mercaptan, 1-naphthyl mercaptan, 1-azulenethiol, 1-anthracenethiol and 4,4′-thiobenzenethiol.

The above heteroaromatic mercaptan may be a compound wherein bonds between the hetero atom-containing aromatic ring (heteroaromatic ring) and the mercapto group are present in at least part of the skeleton, as well as isomers thereof, or mercapto group-bearing derivatives thereof. Specific examples of heteroaromatic mercaptans include 2-pyridyl mercaptan, 2-pyrrolyl mercaptan, 2-indolyl mercaptan, 2-furanyl mercaptan, 2-thiophenethiol, 2-benzothiophenethiol and 2-mercaptopyridimine.

In a preferred aspect of the art disclosed herein, the corrosion-preventing mercaptan accounts for a proportion of the sulfur-containing chain transfer agent used to synthesize the acrylic polymer of at least about 60 mass %, preferably at least about 75 mass %, and more preferably at least about 90 mass %. Substantially all of the sulfur-containing chain transfer agent may be corrosion-preventing mercaptan. The corrosion-preventing mercaptan included in the sulfur-containing chain transfer agent used in the art disclosed herein may be of one species or may be of two or more species. For example, preferred use may be made of a chain transfer agent that is substantially composed of tertiary laurylmercaptan (which may be a mixture of a plurality of structural isomers thereof).

The reasons why sulfur-containing gas emissions by the PSA sheet can be effectively reduced by using such a corrosion-preventing mercaptan are thought to include the following. The acrylic polymer synthesized using mercaptan may become an acrylic polymer having, as the mercaptan residues, sulfur-containing structural moieties. When these structural moieties incur chemical changes, they dissociate from the acrylic polymer, becoming a low-molecular-weight sulfur-containing gas which may cause metal-corrosion. However, in the above-described corrosion-preventing mercaptan, because the carbon atom neighboring the sulfur is bonded to a bulky atomic group or to an atom or atomic group having π electrons, the sulfur-containing structural moieties are thought to have difficulty dissociating form the acrylic polymer.

In a preferred aspect of the art disclosed herein, a compound which substantially does not generate sulfur-containing gases in the above gas generation test (i.e., a sulfur-containing chain transfer agent which substantially does not contribute to the amount of sulfur-containing gases generated in the test) is used as the sulfur-containing chain transfer agent. Tertiary mercaptans (e.g., tertiary alkylmercaptans) and aromatic mercaptans such as those described above are typical examples of materials which may be used as sulfur-containing chain transfer agents that substantially do not contribute to the amount of sulfur-containing gases released.

Sulfur-containing chain transfer agents other than the above may be used provided the preferred sulfur-containing gas emissions disclosed herein can be achieved. Illustrative examples of such chain transfer agents include mercaptans with a structure having at least one mercapto group bonded to a primary carbon atom (also referred to below as primary mercaptans), such as n-laurylmercaptan, 2-mercaptoethanol, mercaptoacetic acid, 2-ethylhexyl thioglycolate and 2,3-dimercapto-1-propanol. However, in an aspect in which only a primary mercaptan is used as the chain transfer agent, it is difficult to achieve the desired adhesive performance while lowering the sulfur-containing gas emissions to the preferred range disclosed here. Therefore, in cases where a primary mercaptan is employed, use in combination with a corrosion-preventing mercaptan such as those described above or a mercaptan which does not contribute to the generation of sulfur-containing gases is preferred. Alternatively, the use of substantially no primary mercaptan is also possible.

In addition to a sulfur-containing chain transfer agent, use may also be made of a chain transfer agent which does not contain sulfur as a constituent atom (a sulfur-free chain transfer agent). Examples of such chain transfer agents that may be used include α-methylstyrene dimer; and terpenes such as α-pinene, limonene and terpinolene. These sulfur-free chain transfer agents are preferably used in a lower molar amount than the sulfur-containing chain transfer agent (e.g., in a number of moles less than one-half the number of moles of the sulfur-containing chain transfer agent). Alternatively, it is acceptable to use no sulfur-free chain transfer agent.

By means of such solution polymerization, a polymer reaction mixture can be obtained in a form where the acrylic polymer is dissolved in a non-toluene organic solvent. It is preferable to use, as the acrylic polymer in the art disclosed herein, the above polymerization reaction mixture or such a reaction mixture which has been suitably worked up. Typically, the acrylic polymer-containing solution obtained following work-up is adjusted to a suitable viscosity (concentration) and used. Alternatively, use may be made of an acrylic polymer solution prepared by using a polymerization method other than solution polymerization (e.g., emulsion polymerization, photopolymerization, or bulk polymerization) to synthesize the acrylic polymer, and dissolving the polymer in a non-toluene organic solvent.

The PSA composition in the art disclosed herein may also include, in addition to the acrylic polymer, a tackifying resin. Tackifying resins that may be used for this purpose include, but are not limited to, various tackifying resins such as rosins, terpenes, hydrocarbons, epoxides, polyamides, elastomers, phenols and ketones. Such tackifying resins may be used singly or as combinations of two or more thereof.

In particular, examples of rosin-type tackifying resins include unmodified rosins (raw rosins) such as rubber rosin, wood rosin and tall oil rosin; modified rosins obtained by hydrogenating, disproportionating, polymerizing or otherwise modifying these unmodified rosins (e.g., hydrogenated rosin, disproportionated rosin, polymerized rosin, and rosins that have been chemically modified in some other way); and other types of rosin derivatives. Examples of such rosin derivatives include rosin esters such as unmodified rosins that have been esterified with alcohols (i.e., esterification products of rosins), and modified rosins (e.g., hydrogenated rosins, disproportionated rosins, polymerized rosins) that have been esterified with alcohols (i.e., esterification products of modified rosins); unsaturated fatty acid-modified rosins obtained by modifying unmodified rosins or modified rosins (e.g., hydrogenated rosins, disproportionated rosins, polymerized rosins) with an unsaturated fatty acid; unsaturated fatty acid-modified rosin esters obtained by modifying rosin esters with an unsaturated fatty acid; rosin alcohols obtained by reduction of the carboxyl groups in unmodified rosins, modified rosins (e.g., hydrogenated rosins, disproportionated rosins, polymerized rosins), unsaturated fatty acid-modified rosins or unsaturated fatty acid-modified rosin esters; metal salts of rosins (especially rosin esters) such as unmodified rosins, modified rosins or various types of rosin derivatives; and rosin phenol resins obtained by thermal polymerization involving the addition of phenol to a rosin (e.g., unmodified rosin, modified rosin, various types of rosin derivatives) using an acid catalyst.

Examples of terpene-type tackifying resins include terpene resins such as α-pinene polymers, β-pinene polymers and dipentene polymers; and modified terpene resins obtained by modifying (e.g., phenolic modification, aromatic modification, hydrogenation, hydrocarbon modification) such terpene resins. Examples of such modified terpene resins include terpene-phenol resins, styrene-modified terpene resins, aromatic modified terpene resins and hydrogenated terpene resins.

Hydrocarbon-type tackifying resins include various types of hydrocarbon resins, such as aliphatic hydrocarbon resins, aromatic hydrocarbon resins, aliphatic cyclic hydrocarbon resins, aliphatic aromatic petroleum resins (e.g., styrene-olefinic copolymers), aliphatic alicyclic petroleum resins, hydrogenated hydrocarbon resins, coumarone resins and coumarone-indene resins. Examples of aliphatic hydrocarbon resins include one or more aliphatic hydrocarbon polymer selected from among olefins and dienes having about 4 or 5 carbons. Examples of olefins include 1-butene, isobutylene and 1-pentene. Examples of dienes include butadiene, 1,3-pentadiene and isoprene. Examples of aromatic hydrocarbon resins include polymers of vinyl group-bearing aromatic hydrocarbons having about 8 to 10 carbons (e.g., styrene, vinyltoluene, α-methylstyrene, indene, methylindene). Examples of aliphatic cyclic hydrocarbon resins include alicyclic hydrocarbon resins obtained by the cyclic dimerization of what is referred to as the “C4 petroleum fraction” or “C5 petroleum fraction,” followed by polymerization; polymers of cyclic diene compounds (e.g., cyclopentadiene, dicyclopentadiene, ethylidene norbornene, dipentene), or hydrogenation products thereof; and alicyclic hydrocarbon resins obtained by hydrogenating the aromatic rings of aromatic hydrocarbon resins or aliphatic-aromatic petroleum resins.

In the art disclosed herein, it is desirable to use a tackifying resin having a softening point (softening temperature) of at least about 80° C. (preferably at least about 100° C.). With such a tackifying resin, a PSA sheet having a higher performance (e.g., higher adhesiveness) can be achieved. The upper limit in the softening point of the tackifying resin is not subject to any particular limitation and may be, for example, about 200° C. or less (typically about 180° C. or less). The tackifying resin softening point mentioned herein is defined as the value measured based on the softening point test method (ring and ball method) described in any of JIS K 5902 and JIS K 2207.

The amount of preservative is not subject to any particular limitation, and may be suitably selected according to the target adhesiveness (bond strength, etc.). For example, it is preferable to use the tackifying resin in an amount (solids basis) of from about 10 to about 100 parts by weight (more preferably 15 to 80 parts by weight, and even more preferably 20 to 60 parts by weight) per 100 parts by weight of the acrylic polymer.

If necessary, a crosslinking agent may be used in the PSA composition. The type of crosslinking agent used is not subject to any particular limitation, and may be suitably selected from among known or conventional crosslinking agents (e.g., isocyanate-type crosslinking agents, epoxy-type crosslinking agents, oxazoline-type crosslinking agents, aziridine-type crosslinking agents, melamine-type crosslinking agents, peroxide-type crosslinking agents, urea-type crosslinking agents, metal alkoxide-type crosslinking agents, metal chelate-type crosslinking agents, metal salt-type crosslinking agents, carbodiimide-type crosslinking agents, and amine-type crosslinking agents). The crosslinking agent may be used singly or as a combination of two or more thereof. The amount of crosslinking agent is not subject to any particular limitation, and may be selected from a range of about 10 parts by weight or less (e.g., from about 0.005 to about 10 parts by weight, and preferably from about 0.01 to about 5 parts by weight) per 100 parts by weight of the acrylic polymer.

If necessary, the PSA composition may include various common additives in the field of PSA compositions, such as an acid or base used for such purposes as pH adjustment, viscosity modifiers (thickeners, etc.), leveling agents, release modifiers, plasticizers, softeners, fillers, colorants (pigments, dyes, etc.), surfactants, antistatic agents, antiseptics, antidegradants, ultraviolet absorbers, antioxidants, light stabilizers and the like.

The PSA layer in the art disclosed herein may be advantageously formed by applying a PSA composition like that described above to a given surface, then drying or curing. When applying the PSA composition (typically, by coating), use may be made of a conventional coater (e.g., gravure roll coater, reverse roll coater, kiss roll coater, dip roll coater, bar coater, knife coater, spray coater). The thickness of the PSA layer is not subject to any particular limitation, and may be, for example, from about 2 μm to about 200 μm (preferably from about 5 μm to about 100 μm).

The PSA sheet having such a PSA layer may be manufactured by any of various methods. For example, in the case of a PSA sheet with substrate, use may be made of a method wherein the PSA composition is applied directly to a substrate, then dried or cured so as to form a PSA layer on the substrate, following which a release liner is laminated onto the PSA layer; or a method wherein a PSA layer formed on a release liner is attached to a substrate, thereby transferring the PSA layer to the substrate, and the release liner is used in situ to protect the PSA layer.

In the PSA sheet disclosed herein, the substrate which supports (backs) the PSA layer may be, for example, a plastic film such as a polyolefin (e.g., polyethylene, polypropylene, ethylene-propylene copolymer) film, a polyester (e.g., polyethylene terephthalate) film, a vinyl chloride resin film, a vinyl acetate resin film, a polyimide resin film, a polyamide resin film, a fluororesin film, or cellophane; a type of paper, such as Japanese paper, kraft paper, glassine, wood-free paper, synthetic paper or topcoated paper; a woven or nonwoven fabric or sheet composed of any of various types of fibrous substances (whether natural fibers, semi-synthetic fibers, or synthetic fibers, examples of which include cotton fibers, staple fibers, Manila hemp, pulp, rayon, acetate fibers, polyester fibers, polyvinyl alcohol fibers, polyamide fibers and polyolefin fibers), either singly or as a blend; a rubber sheet made of, e.g., natural rubber or butyl rubber; foam sheets made of foam such as expanded polyurethane or expanded polychloroprene rubber; a metal foil such as aluminum foil and copper foil; or a composite thereof. The plastic film may be of an unoriented type or an oriented (monoaxially oriented or biaxially oriented) type. The substrate may be in the form of a single layer, or may be in the form of a laminate.

The substrate may optionally contain various additives, such as fillers (e.g., inorganic fillers, organic fillers), antidegradants, antioxidants, ultraviolet absorbers, antistatic agents, lubricants, plasticizers, colorants (e.g., pigments, dyes), and the like. A known or conventional surface treatment, such as corona discharge treatment, plasma treatment or primer coating, may be applied to the substrate surface (in particular, the surface on the side where the PSA layer is provided). Such surface treatment may be, for example, treatment for increasing the anchorability of the PSA layer to the substrate. The thickness of the substrate may be suitably selected according to the intended application, and is generally in a range of from about 10 μm to about 500 μm (preferably from about 10 μm to about 200 μm). The grammage of the substrate (e.g., a nonwoven sheet) may be, for example, in a range of about 5 to 50 g/m², (preferably about 10 to 20 g/m², for example 10 to 15 g/m²).

The release liner which protects or supports the PSA layer (or may have both protective and supporting functions) is not subject to any particular limitation in the material or construction thereof; that is, any suitable release liner may be selected for use from among known release liners. For example, advantageous use may be made of a release liner with a construction wherein release treatment has been applied to at least one surface of a substrate (typically, a release treatment layer made of a release treatment agent has been provided). The substrate in such a release liner (i.e., the substrate which is subjected to release treatment) may be suitably selected for use from among substrates similar to those described above as substrates making up the PSA sheet (e.g., various types of plastic films, papers, fabrics, rubber sheets, foam sheets, metal foils, and composites thereof). A known or conventional release treatment agent (examples of which include silicone, fluorochemical, and long-chain alkyl-type release treatment agents) may be used to form the release treatment layer. Alternatively, a low-adhesion substrate composed of a fluoropolymer (e.g., polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer) or a low-polarity polymer (e.g., olefin resins such as polyethylene and polypropylene) may be used as the release liner without applying any particular release treatment. It is also possible to use as the release liner a low-adhesion substrate to the surface of which a release treatment has been applied.

The thicknesses of the substrate and the release treatment layer making up the release liner are not subject to any particular limitations and may be suitably selected according to the intended purpose and other considerations. For example, the overall thickness of the release liner (in a release liner having a release treatment layer on the substrate surface, the overall thickness which includes the substrate and the release treatment layer) is preferably at least about 15 μm (typically from about 15 μm to about 500 μm), and more preferably from about 25 μm to about 500 μm.

In cases where crosslinking is carried out when the PSA layer is formed, depending on the type of crosslinking agent used (e.g., thermal crosslinking-type agents which crosslink under heating, photocrosslinking-type agents which crosslink on exposure to ultraviolet light), crosslinking may be carried out by a known or conventional crosslinking method in a specific production step. For example, in cases where the crosslinking agent used is a thermal crosslinking-type agent, the thermal crosslinking reaction may be made to proceed in parallel with or simultaneous with drying of the acrylic PSA composition after it has been applied by coating. Specifically, depending on the type of thermal crosslinking agent, crosslinking may be carried out together with drying by holding a temperature at or above the temperature at which the crosslinking reaction proceeds.

In the art disclosed herein, although no particular limitation is imposed on the solvent insolubles (crosslinked acrylic polymer) in the PSA making up the PSA layer, it is generally desirable for such insolubles to account for about 15 to about 70 wt % of the overall PSA layer. As used herein, “solvent insolubles” refers to the weight ratio of insolubles that remains following extraction of the crosslinked PSA with ethyl acetate. Here, it is desirable for the weight-average molecular weight of the solvent solubles (the acrylic polymer obtained by extracting the PSA with tetrahydrofuran) in the PSA, expressed as the polystyrene equivalent molecular weight obtained by gel permeation chromatography (GPC), to be in a range of from about 10×10⁴ to about 200×10⁴ (preferably from about 20×10⁴ to about 160×10⁴). This weight-average molecular weight can be measured with an ordinary GPC system (e.g., a model HLC-8120 GPC system manufactured by Tosoh Corporation; using a TSKgel GMH-H(S) column). The weight ratio of solvent insolubles and the weight-average molecular weight of the solvent solubles may be set as desired by suitably adjusting, for example, the proportion of functional group-bearing monomers relative to the overall monomer components, the type and amount of chain transfer agent, and the type and amount of crosslinking agent.

The PSA sheet disclosed herein is characterized by that the emission of sulfur-containing gas being 0.043 μg SO₄²⁻/cm² or less (and preferably 0.03 μg SO₄²⁻/cm² or less), in a gas generation test whereby the PSA sheet is heated at 85° C. for 1 hour. From the standpoint of the ability to prevent metal corrosion, the sulfur-containing gas emission of the PSA sheet is preferably as low a value as possible at or below the above-indicated value. For this reason, in connection with the materials making up the PSA sheet disclosed herein and the materials used in the production process therefor, it is desirable that, as concerns not only the chain transfer agent used in the synthesis of the acrylic polymer but also other materials, the use of materials which may become a source of sulfur-containing gases be avoided or the amount in which such materials are used be suppressed. For example, with regard to materials other than the chain transfer agent used in the synthesis of the acrylic polymer (e.g., polymerization initiators), tackifiers, various types of additives which may contain a tackifier, crosslinking agents, various additives that may be formulated in the solvent-type PSA composition, PSA sheet substrates and additives therefore, it is preferable to select compounds which do not readily generate sulfur-containing gases (e.g., the compounds which do not). In this way, the metal corrosion-preventing ability of the PSA sheet can be further increased while maintaining a good adhesive performance through the use of a sulfur-containing chain transfer agent. In a preferred aspect, of the sulfur-containing gases released from the PSA sheet in the above gas generation test, the amount contributed by materials other than the chain transfer agent (i.e., the amount of sulfur-containing gas evolution that originates from materials other than the chain transfer agent) is substantially zero. One preferred example disclosed herein is the PSA sheet containing sulfur atom only as a constituent atom of corrosion-preventing mercaptans (typically, consisting of one or more species of mercaptans selected from tertiary mercaptans and aromatic mercaptans) but substantially no other sulfur atom is contained in the PSA sheet.

In a preferred aspect of the PSA sheet disclosed herein, in the above gas generation test, of the amount of sulfur-containing gases released from the PSA sheet, the amount contributed by the sulfur-containing chain transfer agent (i.e., the amount of sulfur-containing gas evolution that originates from the sulfur-containing chain transfer agent) is 0.03 μg SO₄²⁻/cm² or less (and more preferably, below 0.02 μg SO₄²⁻/cm²). According to this aspect, it is easy to hold the total amount of the sulfur-containing gas emission of the PSA sheet to 0.043 μg SO₄²⁻/cm² or below. This is desirable because it affords a broader range of options for the sulfur-containing chain transfer agent material and the amount of use thereof. In a preferred aspect, the amount of sulfur-containing gas emissions that originates from the surface-containing chain transfer agent is substantially zero (typically, less than 0.02 μg SO₄²⁻/cm²).

The art disclosed herein may be used to prevent the corrosion of various metals which may react and be altered (e.g., sulfide formation) by sulfur-containing gases (e.g., H₂S, SO₂). Examples of such metals that are to be prevented from corroding include transition metals such as silver, copper, titanium, chromium, iron, cobalt, nickel and zinc; and metals included among typical elements, such as aluminum, indium, tin and lead. Because of the ease with which they are corroded by sulfur-containing gases and because they are widely used as structural materials in substrates and wiring, especially preferred examples of metals that are to be prevented from corroding include silver and silver alloys (alloys in which the primary component is silver). According to a preferred aspect of the PSA sheet disclosed herein, when 1.0 g of the PSA sheet (which includes a PSA layer and substrate, but does not include a release liner) and a silver plate are placed in a non-contact state within a closed space having a volume of 50 mL and held at 85° C. for one week, a degree of metal corrosion preventability can be achieved where, on visual examination, the silver plate undergoes no observable changes in appearance (e.g., decrease or disappearance of metal luster, blackening or other discoloration) indicative of corrosion.

The PSA sheets disclosed herein enables metal corrosion and undesirable effects associated therewith (poor electrical contact, diminished quality of appearance, etc.) to be reliably prevented or minimized because the emission of the sulfur-containing gas is highly minimized as described above. These PSA sheets can thus be advantageously used for such purposes as bonding components, surface protection, displaying information, sealing or filling holes and gaps, and damping vibrations and impact at the interior of housings for television sets (e.g., liquid-crystal, plasma and cathode ray TVs), computers (e.g., displays and main units), acoustic equipment and various other types of electrical appliances, office automation equipment and the like. These PSA sheets are especially preferred for use in environments (e.g., the housing of a liquid-crystal TV) where the temperature within the housing tends to rise with use of the electronic device, facilitating the generation of sulfur-containing gases and in turn promoting metal corrosion. With the PSA sheet disclosed herein, high metal anti-corrosion effects can be exhibited even in such a manner of use.

Because the PSA sheet disclosed herein has a PSA layer formed of an acrylic polymer-containing non-toluene solvent-based PSA composition and synthesis of the acrylic polymer is carried out in the presence of a sulfur-containing chain transfer agent, it is capable of exhibiting both a high level of metal corrosion preventability and an excellent adhesive performance. Accordingly, such a PSA sheet can be suitably used at the interior of an electronic device and other places as a PSA sheet for bonding components that require a high PSA performance (e.g., adhesive strength). Moreover, the art disclosed herein may be advantageously applied to a double-sided PSA sheet composed of a sheet-shaped substrate (typically, a nonwoven fabric or other porous substrate) having on each side thereof a PSA layer. In double-sided PSA sheets, owing to the importance of having the PSA composition thoroughly penetrate the substrate when the PSA layers are formed and because a high adhesive performance tends to be required, it is particularly significant to have the ability to adjust the molecular weight through the use of a sulfur-containing chain transfer agent. Although not subject to any particular limitation, the thickness of the PSA layers in the double-sided PSA sheet may be set to from about 20 μm to about 150 μm (preferably about 30 μm to 100 μm, typically about 40 μm to 80 μm, for example about 50 μm to 70 μm) per side.

According to this specification, there is also provided a solvent-type PSA composition which includes an acrylic polymer synthesized within a non-toluene organic solvent and in the presence of a sulfur-containing chain transfer agent, and which provides a PSA having sulfur-containing gas emissions in the above-described gas generation test of below 2.7 μg SO₄²⁻/g (more preferably 1.9 μg SO₄²⁻/g or less, such as below 1.2 μg SO₄²⁻/g) (which PSA is typically formed by drying or curing). Such a PSA composition may be suitably employed in, for example, the production of any of the PSA sheets disclosed herein. Moreover, because the PSA composition is capable of forming a PSA having low sulfur gas emissions as indicated above, it is suitable for applications wherein a PSA (which is not limited to sheet form, and may be in bulk form or various other forms) having such functions as sealing, filling and cushioning is formed at the interior of electronic device housings and other places.

According to the art disclosed herein, a PSA sheet which has an adhesive strength (capable of being determined by the subsequently described adhesive strength measurement) with respect to a stainless steel plate (SUS: BA304) of at least about 4 N/20 mm (typically from 4 to 20 N/20 mm) can be obtained. In a preferred aspect, a PSA sheet having an adhesive strength of at least about 5 N/20 mm (more preferably at least about 7 N/20 mm, such as 8 N/20 mm or more) can be obtained.

### EXAMPLES

Several experimental examples of the invention are described below, although these specific examples are not intended to limit the scope of the invention. In the description that follows, unless noted otherwise, all references to “parts” and “%” are based on weight.

### Example 1

A reactor equipped with a condenser, a nitrogen inlet, a thermometer and a stirrer was charged with 97 parts of BA, 3 parts of acrylic acid, 0.05 part of tertiary-laurylmercaptan (t-LSH) and 50 parts of ethyl acetate, and the reactor was purged with nitrogen gas by stirring the reactor contents at 70° C. for at least 1 hour while introducing nitrogen gas. Next, 0.5 part of benzoyl peroxide was added to this reactor. The reaction mixture was stirred for 7 hours while holding the temperature at 70° C., thereby giving an acrylic polymer. During the reaction, 120 parts of ethyl acetate was added dropwise to control the temperature. Next, 6 parts of “Coronate L” (a crosslinking agent containing 75% of the trimethylolpropane addition product of tolylene diisocyanate; available under this trade name from Nippon Polyurethane Industry Co., Ltd.) was added per 100 parts of this acrylic polymer, following which the mixture was diluted with ethyl acetate to a coatable viscosity, yielding the solvent-type acrylic PSA composition of Example 1.

The above PSA composition was coated onto a release liner having a release treatment layer obtained with a silicone-based release agent (available from Oji Paper Co., Ltd. under the trade name “75EPS (M) Cream (Modified)”), then dried at 100° C. for 2 minutes, thereby forming a PSA layer having a thickness of about 60 μm. Two sheets of this release liner with PSA layer were prepared, and the PSA layers were respectively laminated to each side of the nonwoven fabric substrate (available under the trade name “SP Genshi-14” from Daifuku Paper Manufacturing Co., Ltd.; grammage, 14 g/m²), thereby fabricating a double-sided PSA sheet in a form wherein both PSA sides were protected directly by the release liners used in the production of the PSA sheets.

### Example 2

Instead of the t-LSH used in Example 1, use was made of 0.05 part of tertiary-butylmercaptan (t-BuSH). In other respects, a solvent-type acrylic PSA composition was used in the same way as in Example 1. Aside from using this composition, a double-sided PSA sheet was fabricated in the same way as in Example 1.

### Example 3

Instead of the t-LSH used in Example 1, use was made of 0.05 part of benzenethiol (phenylmercaptan; PhSH). In other respects, a solvent-type acrylic PSA composition was used in the same way as in Example 1. Aside from using this composition, a double-sided PSA sheet was fabricated in the same way as in Example 1.

### Example 4

Instead of the t-LSH used in Example 1, use was made of 0.05 part of n-laurylmercaptan (n-LSH). In other respects, a solvent-type acrylic PSA composition was used in the same way as in Example 1. Aside from using this composition, a double-sided PSA sheet was fabricated in the same way as in Example 1.

The following measurements and evaluations were carried out on each of the PSA sheets in Examples 1 to 4. The results are shown in Table 1. The species of chain transfer agent used in polymerization in each example are shown together in Table 1.

### Measurement of Adhesive Strength to SUS Stainless Steel

A first release liner was peeled from each double-sided PSA sheet, and a polyethylene terephthalate (PET) film having a thickness of 25 μm was bonded thereto as a backing. This PET film-backed PSA sheet was cut into measurement samples having a size of 20 mm×100 mm. The second release liner was peeled from the sample and pressure-bonded to a stainless steel (SUS) sheet by passing a 2 kg roller back-and-forth over it once. This was then held at 23° C. for 30 minutes, following which the 180° peel adhesive strength was measured in a 23° C., 50% RH environment at a test rate of 300 mm/min in general accordance with JIS Z 0237.

### Measurement of Sulfur-Containing Gas Emissions

A 0.1 g sample of each PSA sheet of which the release liner was peeled off from each adhesive surface was placed on a sample boat for a combustion system and was heated at 85° C. for 1 hour using a combustion system (a model AQF-100 automated sample combustion system manufactured by Dia Instruments). The gas generated from the PSA sheet in so doing was passed through 10 mL of an absorption solution. This absorption solution comprised 30 ppm hydrogen peroxide in pure water, allowing the sulfur-containing gas (H₂S, SO₂ and the like) that may be included in the generated gas described above to be converted into SO₄²⁻ and collected. The absorption solution after passage of the generated gas was added with pure water to adjust the volume to 20 mL, and the amount of SO₄²⁻ generated per 1 g of PSA sheet was determined by carrying out a quantitative analysis of SO₄²⁻ using an ion chromatograph (manufactured by Dionex; product name: DX-320). Note that similar operations were carried out with the sample boat described above in an empty state, which served as blank. The obtained results were converted into amounts of SO₄²⁻ generated per surface area of each PSA sheet and amounts of SO₄²″ generated per 1 g of PSA. These results are shown in Table 1. Note that in the conversion described above used the facts that the mass per 1 cm² of PSA sheet according to each example was 0.017 g, and that the mass of PSA contained in 1 cm² of each PSA sheet was 0.0156 g.

### Operating Conditions of Automated Sample Combustion System

Temperature: Inlet, 85° C.; Outlet, 85° C.

Gas Flow Rate: 400 mL of O₂/min, 150 mL of Ar (water supply unit: scale 0)/min

### Measurement Conditions Using Ion Chromatograph (Anion)

Separation Column: IonPac AS18 (4 mm×250 mm)
Guard Column: IonPac AG18 (4 mm×50 mm)
Suppression System: ASRS-ULTRA (external mode, 75 mA)
Detector: electrical conductivity detector
Eluant: 13 mM KOH (0 to 20 minutes) 30 mM KOH (20 to 30 minutes) (using EG40 eluant generator)
Eluant Flow Rate: 1.0 mL/min
Sample Injection Rate: 250 μL

### Metal Corrosivity Test

Each of the PSA sheets from which release liners had been peeled from both adhesive faces (and which thus consisted of the nonwoven fabric substrate and the PSA layers provided on each side thereof) in an amount of 1.0 g and a polished silver plate (silver purity >99.95%; size, 1 mm×10 mm×10 mm) were furnished. The PSA sheet and the silver plate were placed in a 50 mL screw-cap tube so as not to come into direct contact with each other, following which the tube was sealed and stored at 85° C. for one week. Metal corrosion was evaluated by comparing the silver plate following the test with the silver plate prior to use (before the test), and visually checking for the presence or absence of corrosion (which was judged based on changes in appearance, such as a loss of metal luster and discoloration). The metal corrosion results are indicated in Table 1 as “Yes” when corrosion was observed, and as “No” when corrosion was not observed.

TABLE 1

| | Example 1 | Example 2 | Example 3 | Example 4 |
|---|---|---|---|---|
| Chain transfer agent | t-LSH | t-BuSH | PhSH | n-LSH |
| Adhesive strength to | 9.3 | 9.0 | 8.5 | 9.0 |
| SUS (N/20 mm) | | | | |
| Amount of SO₄²⁻ | <1.1 | <1.1 | <1.1 | 2.7 |
| generated per 1 g of PSA | | | | |
| sheet (μg/g) | | | | |
| Amount of SO₄²⁻ | <0.019 | <0.019 | <0.019 | 0.045 |
| generated per 1 cm² of | | | | |
| PSA sheet (μg/cm²) | | | | |
| Amount of SO₄²⁻ | <1.2 | <1.2 | <1.2 | 2.9 |
| generated per 1 g of | | | | |
| PSA (μg/g) | | | | |
| Metal corrosion | No | No | No | Yes |

As shown in Table 1, the PSA sheets according to Examples 1 to 3 in which a tertiary alkyl mercaptan or an aromatic mercaptan was used as the chain transfer agent all exhibited a good PSA strength and had an amount of sulfur-containing gas emission of 0.043 μg SO₄²⁻/cm² or less (specifically, less than 0.020 μg SO₄⁻²/cm²). Moreover, silver corrosion in the above metal corrosivity test was confirmed to be absent in the PSA sheets according to these Examples 1 to 3. On the other hand, in Example 4, which used a primary alkyl mercaptan (n-LSH) as the chain transfer agent, although an adhesive strength comparable to those in Examples 1 to 3 was obtained, the amount of sulfur-containing gases evolution was large, and silver corrosion was confirmed in the above metal corrosivity test. That is, with Examples 1 to 3, remarkable effects were achieved in that the problem of metal corrosion was resolved while at the same time demonstrating an adhesive performance similar to that in Example 4.

The embodiments thus disclosed in detail above are to be considered in all respects as illustrative and not limiting. The scope of the invention is indicated by the appended claims rather than by the foregoing description, and all changes which come within the meaning and range of equivalency of the claims are intended to be embraced therein.

1. A pressure-sensitive adhesive sheet comprising a pressure-sensitive adhesive layer formed from a solvent-based pressure-sensitive adhesive composition,
wherein the pressure-sensitive adhesive composition includes, within an organic solvent that is substantially free of toluene substances, an acrylic polymer synthesized in presence of a chain transfer agent containing sulfur as a constituent atom, and
in a gas generation test whereby the pressure-sensitive adhesive sheet is heated at 85° C. for 1 hour, the emission of gas containing sulfur as a constituent atom is 0.043 μg or less per 1 cm² surface area of the sheet when converted to SO₄²⁻.

2. The pressure-sensitive adhesive sheet according to claim 1, wherein the chain transfer agent is a chain transfer agent which substantially does not generate the sulfur containing gas in the gas generation test.

3. The pressure-sensitive adhesive sheet according to claim 1, wherein the chain transfer agent comprises as a main component a mercaptan with a structure having no hydrogen atom on a carbon atom bonded to a mercapto group.

4. The pressure-sensitive adhesive sheet according to claim 3, wherein the mercaptan is one or two or more species selected from the group consisting of tertiary mercaptans.

5. The pressure-sensitive adhesive sheet according to claim 3, wherein the mercaptan is one or two or more species selected from the group consisting of aromatic mercaptans.

6. The pressure-sensitive adhesive sheet according to claim 1, wherein the organic solvent has a boiling point under a pressure of 1 atm which lies in a range of from 25° C. to 109° C.

7. The pressure-sensitive adhesive sheet according to claim 1, wherein the organic solvent is one or two or more species selected from the group consisting of ethyl acetate, hexane, cyclohexane, methylcyclohexane and isopropyl alcohol.

8. The pressure-sensitive adhesive sheet according to claim 1, which is constituted as a double-sided pressure-sensitive adhesive sheet comprising a substrate having on each side thereof the pressure-sensitive adhesive layer.

9. The pressure-sensitive adhesive sheet according to claim 1, which is adapted for use inside an electronic device.

10. The pressure-sensitive adhesive sheet according to claim 1, wherein the sulfur containing chain transfer agent is consisting of one or more species of mercaptans selected from tertiary mercaptans and aromatic mercaptans,
the organic solvent is one or two or more species selected from the group consisting of ethyl acetate, hexane, cyclohexane, methylcyclohexane and isopropyl alcohol, and
being constituted as a double-sided pressure-sensitive adhesive sheet comprising a substrate having on each side thereof the pressure-sensitive adhesive layer.

11. The pressure-sensitive adhesive sheet according to claim 10, wherein the acrylic polymer is synthesized by using 0.01 to 1 parts by mass of the sulfur containing chain transfer agent per 100 parts by mass of the monomer components.

12. The pressure-sensitive adhesive sheet according to claim 11, wherein the substrate is a nonwoven sheet having a grammage of 10 to 20 g/m², and
the thickness of the pressure-sensitive adhesive layer is 40 μm to 80 μm per side.

13. The pressure-sensitive adhesive sheet according to claim 12, which contains sulfur atom only as a constituent atom of the sulfur containing chain transfer agent but contains substantially no other sulfur atom.

14. An electronic device comprising a housing, a component placed in the housing, and the pressure-sensitive adhesive sheet according to claim 8 bonded to the component.

15. An electronic device comprising a housing, a component placed in the housing, and the pressure-sensitive adhesive sheet according to claim 13 bonded to the component.
